(19) United States
(12) Patent Application Publication
(10) Pub. No.: US 2015/0344705 A1
(43) Pub. Date: Dec. 3, 2015

(54) METHOD FOR BIOFOULING MITIGATION USING A SURFACE COATING WITH MAGNETICALLY ALIGNED PARTICLES

(71) Applicant: Teledyne Scientific & Imaging, LLC, Thousand Oaks, CA (US)

(72) Inventors: Rahul Ganguli, Oak Park, CA (US); Vivek Mehrotra, Simi Valley, CA (US); J. Eric Henckel, Houston, TX (US)

(73) Assignee: Teledyne Scientific & Imaging, LLC, Thousand Oaks, CA (US)

(21) Appl. No.: 14/292,113

(22) Filed: May 30, 2014

(51) Int. Cl. C09D 5/16; G01V 13/00

(52) U.S. Cl. CPC C09D 5/1681; C09D 5/1687; C09D 5/1662; G01V 13/00

(57) ABSTRACT

A method for biofouling mitigation using a surface coating with magnetically aligned particles. A coating material that requires curing is provided, to which magnetic particles are added; this coating is applied to a surface. The applied coating is then subjected to a magnetic field in situ such that the magnetic particles are formed into microstructures that render the surface rougher than it would be without the microstructures. The coating is then allowed to cure. The random and non-toxic surface features created by the magnetic particles and magnetic field provide the coated surface with broad spectrum fouling resistance against organisms such as barnacles and bacteria.

### BACKGROUND OF THE INVENTION

1. Field of the Invention

This invention relates generally to techniques for resisting or preventing the occurrence of biofouling on a surface.

2. Description of the Related Art

There are numerous situations in which a surface needs to be resistant to the growth of various organisms. For example, surfaces immersed in bodies of water, such as the ocean, can become fouled by marine life. Additional examples includes surfaces in a hospital or in a food preparation facility that need to be resistant to the growth of bacteria.

One such situation involves the use of ‘marine streamers’—i.e., long cables that are deployed in the ocean and used for seismic exploration. Typically, streamers (which can be 75 meters long or more) are spooled for transportation to ships, and are unspooled when ready to be used. However, once unspooled into the ocean, streamer cables are susceptible to fouling, especially from barnacles. Very high maintenance costs can be incurred in keeping such cables clean. One way to combat this is to apply a toxic coating such as tributyl tin on the streamer. However, such coatings may be subject to complex regulations.

Another approach is to use a sticky, soft—but non-toxic—coating on the streamer. An example would be the silicone-based coatings currently gaining market acceptance as non-toxic ship hull coatings. However, such coatings can lead to a ‘self stiction’ problem in which sections of the streamer stick to each other when the streamer is spooled, thereby damaging the coating. Another problem is that a very large shear may be needed to dislodge some foulants.

Yet another approach is to use photolithography to create a specific foul-resistant pattern on the surface. However, this can be very expensive, and may be impractical for large surfaces such as a marine streamer.

In a hospital setting, a toxic coating such as silver ion can serve as an anti-microbial coating. This approach may also be subject to strict regulations, and may pose a danger to patients and staff that come into contact with the coated surface.

### SUMMARY OF THE INVENTION

A method for biofouling mitigation using a surface coating with magnetically aligned particles is presented, which provides a practical, low cost rough surface coating which resists the growth of organisms such as marine life and bacteria.

The present method comprises providing a coating material that requires curing, adding magnetic particles to the coating material, applying the coating material with the magnetic particles to the surface to be coated, subjecting the applied coating to a magnetic field in situ such that the magnetic particles are formed into microstructures that render the surface to be coated rougher than it would be without the microstructures, and allowing the coating to cure. The random and non-toxic surface features created by the magnetic particles and magnetic field provide the coated surface with broad spectrum fouling resistance against organisms such as barnacles and bacteria.

The coating material preferably comprises a fast curing polymer, and the magnetic particles are preferably anisotropic nanoparticles. In practice, the surface to be coated has an associated axis, and the magnetic field is oriented such that it is normal to the axis.

These and other features, aspects, and advantages of the present invention will become better understood with reference to the following drawings, description, and claims.

### BRIEF DESCRIPTION OF THE DRAWINGS

FIG. 1 is a flow diagram illustrating the steps of the present method.

FIGS. 2a and 2b are diagrams illustrating the effect of a smooth surface versus a surface coated as described herein on the ability of a barnacle to attach to the surface.

FIG. 3 is a diagram depicting a coated surface being subjected to a magnetic field, and a photomicrograph of the resulting microstructures.

FIG. 4 is a graph plotting relative settlement rate (of barnacles on a streamer cable) versus peak sharpness.

FIG. 5 is a diagram illustrating the application of a magnetic field to a streamer cable coated as described herein.

### DETAILED DESCRIPTION OF THE INVENTION

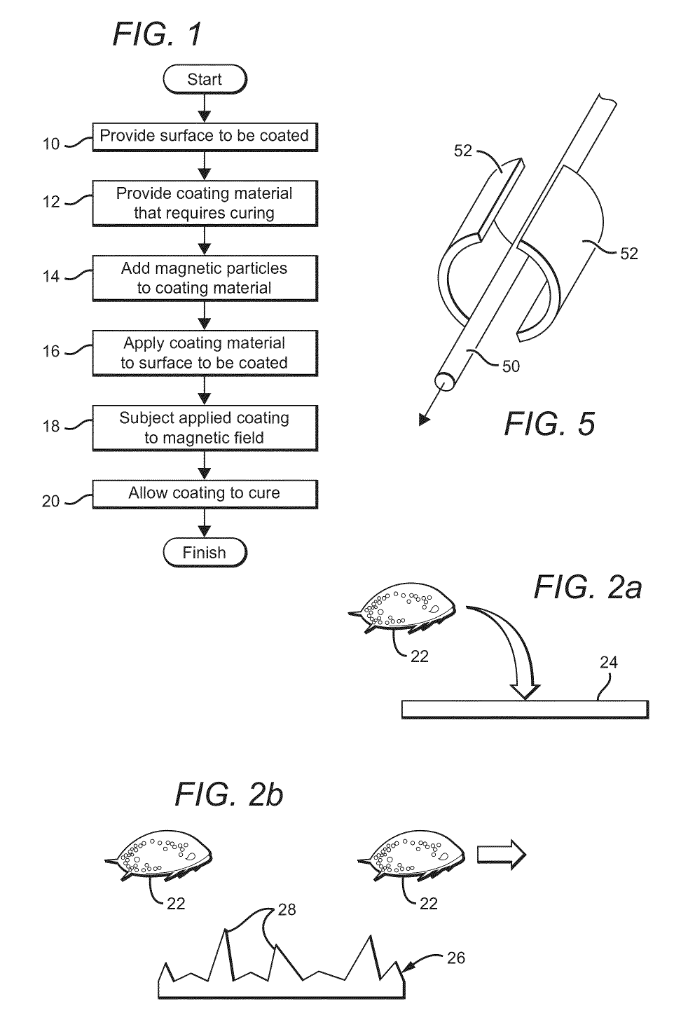

The present method for biofouling mitigation using a surface coating with magnetically aligned particles is illustrated in FIG. 1. In step 10, a surface to be coated is provided. In step 12, a coating material that requires curing is provided. Magnetic particles are added to the coating material in step 14, and the coating material with the magnetic particles is then applied to the surface to be coated (step 16).

In step 18, the applied coating is subjected to a magnetic field in situ, such that the magnetic particles align and form into microstructures which make the coated surface rougher than it would be without the microstructures. The coating is then allowed to cure (step 20), completing the process.

The present method could be used with any surface on which biofouling might occur. For example, a coating with magnetically aligned particles as described herein could be applied to the surface of a streamer cable used in the ocean, to discourage the attachment of marine life such as barnacles to the cable. This is illustrated in FIGS. 2a and 2b. In FIG. 2a, a barnacle 22 that comes into contact with a smooth surface 24 can attach itself to the surface, thereby fouling it. However, in FIG. 2b, a coating 26 as described herein has been applied to the surface. The microstructures 28 formed from the aligned magnetic particles serve to make the surface ‘spiky’, making it difficult for barnacles 22 to attach. The present method might also be used to provide a coating on a ship's hull, to discourage the attachment of marine life such as barnacles to the hull.

The present method might also be used to provide a coating to mitigate the fouling of surfaces with bacteria; this can be particularly important in the medical and food industries. For example, with respect to the food industry, the colonization of bacteria on equipment surfaces—which is exacerbated in environments containing food particles—can be very harmful for equipment that comes into contact with food. However, the non-toxic spiky surface produced by the present method reduces biofilm colonization on the surface. Many other applications are possible. For example, common surfaces such as those on optical windows or LCD panels can be adversely affected by biofouling, and thus could benefit from the present method.

The coating material is preferably a polymer matrix, with a fast curing polymer. The curing process is preferably catalyst-based, UV-based or thermal. The coating material is preferably selected from a group consisting of epoxies, silicones, polyurethanes, acrylates, styrene, terephthalates, nylons, polyethylene, polypropylene, and rubbers.

The magnetic particles preferably comprise nanoparticles which have a high magnetic susceptibility. The magnetic particles are preferably based on materials selected from a group consisting of nickel platelets, cobalt, iron, gadolinium, neodymium or samarium, or mixtures thereof. The magnetic particles are preferably anisotropic, with a diameter of 2-3 microns and a thickness of 0.2 microns or less. Needle-shaped particles are preferred.

When a coating as described herein has been applied to the surface, the applied coating is subjected to a magnetic field in situ such that the magnetic particles are formed into microstructures that serve to roughen the coated surface. The surface to be coated typically has an associated primary axis; the magnetic field is preferably oriented such that it is normal to the axis.

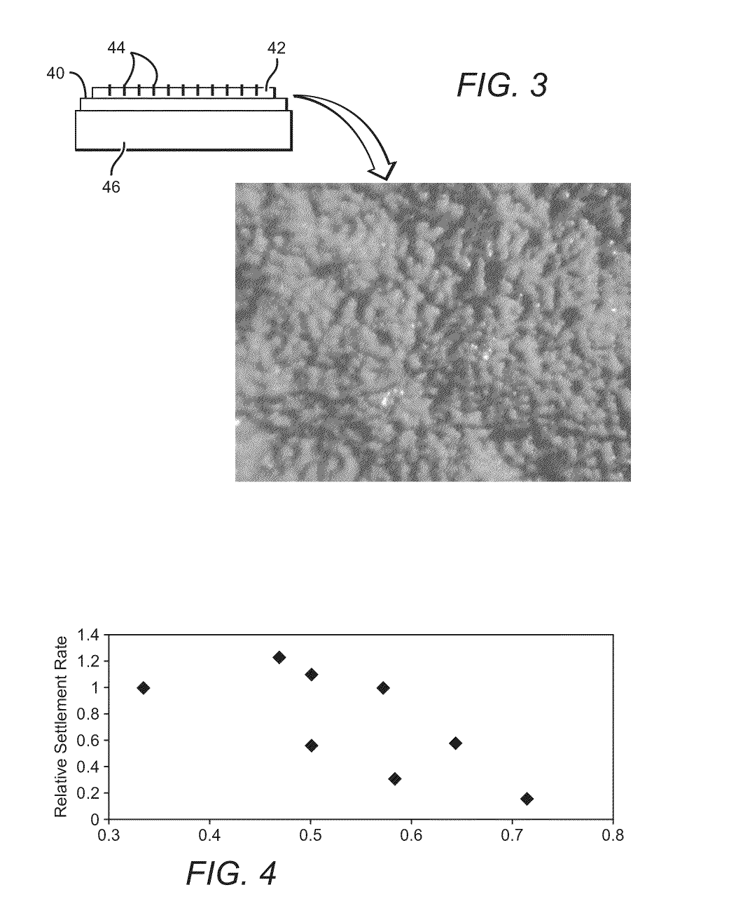

This is illustrated in FIG. 3. A surface 40 is coated with a surface coating 42 as described above, which includes magnetic particles 44 within the coating material. Surface coating 44 is subjected to an orienting magnetic field, here via a magnet 46, which aligns the magnetic particles and causes them to aggregate. The aligned, aggregated particles form spiky microstructures; these can be seen in the photomicrograph in FIG. 3, in which the spikes provided by the microstructures are clearly visible. The coating material is then allowed to cure, locking the microstructures into place. Microstructures such as those shown in FIG. 3 provide broad spectrum biofouling resistance for applied coating 42.

The concentration of magnetic particles within the coating material affects the base radius and quantity of the resulting microstructures. For example, a concentration of magnetic particles of 1% (by weight) in the coating's polymer matrix will produce microstructures that are sharper (i.e., with a smaller base radius) than a coating with a 2% concentration, but the 1% concentration will produce fewer microstructures than will the 2% concentration.

“Peak sharpness” is one measure of a structure's shape, defined as the height of the structure divided by its base radius. Thus, as discussed above, a microstructure with a smaller base radius will have a greater ‘peak sharpness’. It has been determined that the peak sharpness' of the microstructures formed as described herein have an impact on the effectiveness of the coating in mitigating biofouling. For example, a set of experiments were performed to determine the effect of peak sharpness on the ability of barnacles to settle on a streamer cable. This data is shown in FIG. 4, which plots relative settlement rate (of barnacles on a streamer cable) versus peak sharpness. The data generally indicate that relative settlement rate decreases with increasing peak sharpness.

As noted above, the coating material is allowed to cure after being subjected to a magnetic field in situ. It is preferred that curing occur while the magnetic field is being applied; the microstructures tend to lose sharpness if the coating is allowed to cure in the absence of the magnetic field.

FIG. 5 is a diagram illustrating the application of a magnetic field to a streamer cable coated as described herein. Here, the cable 50 has had a coating applied to its surface as described above. The applied coating is subjected to a magnetic field in situ by drawing streamer cable 50 through a pair of magnets 52, which could be permanent magnets or electro-magnets, thereby forming the magnetic particles in the coating material into microstructures. In this way, magnetic alignment of the particles in a coating applied can be made a continuous process, which can facilitate the application of a coating as described herein over a large surface area.

The present method provides a low cost, non-toxic coating that can be applied over surfaces many meters long. The method provides high throughput, and is more commercially feasible than other techniques such as photolithography-based patterning.

The embodiments of the invention described herein are exemplary and numerous modifications, variations and rearrangements can be readily envisioned to achieve substantially equivalent results, all of which are intended to be embraced within the spirit and scope of the invention as defined in the appended claims.

We claim:

1. A method of providing a surface coating having a rough surface, comprising:
providing a surface to be coated;
providing a coating material that requires curing;
adding magnetic particles to said coating material;
applying said coating material with said magnetic particles to said surface to be coated;
subjecting said applied coating to a magnetic field in situ such that said magnetic particles are formed into microstructures that render said surface to be coated rougher than it would be without said microstructures; and
allowing said coating to cure.

2. The method of claim 1, wherein said surface to be coated is the surface of a streamer cable.

3. The method of claim 1, wherein said surface to be coated is a ship's hull.

4. The method of claim 1, wherein said coating material is a polymer matrix.

5. The method of claim 4, wherein said coating material is selected from a group consisting of epoxies, silicones, polyurethanes, acrylates, styrene, terephthalates, nylons, polyethylene, polypropylene, and rubbers.

6. The method of claim 1, wherein said coating material is a fast curing polymer.

7. The method of claim 6, wherein said curing is catalyst-based, UV-based or thermal.

8. The method of claim 1, wherein said magnetic particles comprise nanoparticles.

9. The method of claim 1, wherein said magnetic particles have a high magnetic susceptibility.

10. The method of claim 1, wherein said magnetic particles are based on materials selected from a group consisting of nickel platelets, cobalt, iron, gadolinium, neodymium or samarium, or mixtures thereof.

11. The method of claim 1, wherein said magnetic particles are anisotropic.

12. The method of claim 1, wherein said magnetic particles have a diameter of 2-3 microns and a thickness of 0.2 microns or less.

13. The method of claim 1, wherein said magnetic particles are needle-shaped.

14. The method of claim 1, wherein said surface to be coated has an associated axis, said magnetic field oriented such that it is normal to said axis.

15. The method of claim 1, wherein said microstructures provide broad spectrum biofouling resistance for said applied coating.

16. A surface coating which includes microstructures, comprising:
a coating material which requires curing; and
magnetic particles contained within said coating material which has been formed into microstructures due to exposure to a magnetic field prior to or while said coating material was curing, said microstructures arranged such that, when said surface coating is applied to a surface, said surface is rendered rougher than it would be without said microstructures.

17. The surface coating of claim 16, further comprising a streamer cable to which said surface coating is applied.

18. The surface coating of claim 16, further comprising a ship's hull to which said surface coating is applied.

19. The surface coating of claim 16, wherein said coating material is a polymer matrix.

20. The surface coating of claim 19, wherein said coating material is selected from a group consisting of epoxies, silicones, polyurethanes, acrylates, styrene, terephthalates, nylons, polyethylene, polypropylene, and rubbers.

21. The surface coating of claim 19, wherein said coating material is a fast curing polymer.

22. The surface coating of claim 16, wherein said magnetic particles have a high magnetic susceptibility.

23. The surface coating of claim 16, wherein said magnetic particles are based on materials selected from a group consisting of nickel platelets, cobalt, iron, gadolinium, neodymium or samarium, or mixtures thereof.

24. The surface coating of claim 16, wherein said magnetic particles are anisotropic.

25. The surface coating of claim 16, wherein said magnetic particles have a diameter of 2-3 microns and a thickness of 0.2 microns or less.

26. The surface coating of claim 16, wherein said magnetic particles are needle-shaped.

27. The surface coating of claim 16, wherein said microstructures provide broad spectrum biofouling resistance for said surface coating.
